(19) United States
(12) Patent Application Publication
(10) Pub. No.: US 2023/0297381 A1
(43) Pub. Date: Sep. 21, 2023

(54) Load Dependent Branch Prediction

(71) Applicant: Advanced Micro Devices, Inc., Santa Clara, CA (US)

(72) Inventors: Chetana N. Keltcher, Lexington, MA (US); Alok Garg, Maynard, MA (US); Paul S Keltcher, Lexington, MA (US)

(73) Assignee: Advanced Micro Devices, Inc., Santa Clara, CA (US)

(21) Appl. No.: 17/699,855

(22) Filed: Mar. 21, 2022

(51) Int. Cl. G06F 9/38; G06F 9/30

(52) U.S. Cl. CPC G06F 9/3806; G06F 9/30043

(57) ABSTRACT

Load dependent branch prediction is described. In accordance with described techniques, a load dependent branch instruction is detected by identifying that a destination location of a load instruction is used in an operation for determining whether a conditional branch is taken or not taken. The load instruction is included in a sequence of load instructions having addresses separated by a step size. An instruction is injected in an instruction stream of a processor for fetching data of a future load instruction using an address of the load instruction offset by a distance based on the step size. An additional instruction is injected in the instruction stream of the processor for precomputing an outcome of a load dependent branch using an address computed based on an address of the operation and the data of the future load instruction.

### BACKGROUND

When a conditional branch instruction is identified in an instruction pipeline of a processor, a branch predictor predicts an outcome for the conditional branch as either being taken or not taken before the outcome is known definitively. Instructions are then speculatively executed based on the predicted outcome. If the predicted outcome is correct, then the speculatively executed instructions are used and a delay is avoided. If the predicted outcome is not correct, then the speculatively executed instructions are discarded and a cycle of an instruction stream restarts using the correct outcome, which incurs the delay.

### BRIEF DESCRIPTION OF THE DRAWINGS

The detailed description is described with reference to the accompanying figures.

FIG. 1 is a block diagram of a non-limiting example system having a prefetch controller for prefetching data likely to be requested by an execution unit of the system in one or more implementations.

FIG. 2 illustrates a non-limiting example of a representation of an array having elements used in conditional branches.

FIGS. 3A and 3B illustrate a non-limiting example of a system that improves branch prediction by precomputing outcomes of load dependent branches based on predictability of addresses for future load instructions.

FIG. 4 depicts a procedure in an example implementation of injecting an instruction in an instruction stream of a processor for fetching data of a future load instruction.

FIG. 5 depicts a procedure in an example implementation of injecting an instruction in an instruction stream of a processor for precomputing an outcome of a load dependent branch.

### DETAILED DESCRIPTION

Overview

Branch prediction generally refers to techniques in which an outcome of a conditional branch instruction (e.g., whether the branch is taken or is not taken) is predicted before the outcome is known definitively. Instructions are then fetched and speculatively executed based on the predicted outcome. If the predicted outcome is correct, then the speculatively executed instructions are usable and a delay is avoided. If the predicted outcome is not correct, then the speculatively executed instructions are discarded and a cycle of an instruction stream restarts using the correct outcome, which incurs the delay. Accordingly, increasing an accuracy of predictions made by a branch predictor of a processor improves the processor's overall performance by avoiding the delays associated with incorrect predictions.

Outcomes of conditional branch instructions which depend on data fetched by separate load instructions (load dependent branches) are frequently predicted incorrectly by branch predictors. This is because the data fetched by the separate load instructions is typically random and/or is difficult to predict ahead of time. Due to this, conventional techniques that predict an outcome of a branch, e.g., based on branch history, are not able to accurately predict an outcome for load dependent conditional branches on a consistent basis.

When an outcome of a load dependent branch is predicted incorrectly, instructions speculatively executed based on the incorrect prediction are discarded. This unnecessarily consumes processor resources and creates a delay, e.g., to execute instructions based on the correct outcome. In order to increase an accuracy of predicted outcomes for load dependent branches, techniques described herein use existing hardware of a processor to identify striding load driven branch pairs in an instruction stream and to precompute outcomes of respective load dependent branches. This includes identifying a load instruction that is included in a sequence of load instructions having predictable addresses. The predictability of these addresses is then used to fetch data of a future load instruction, which the described system uses to precompute an outcome of a load dependent branch. The precomputed outcome is significantly more accurate than an outcome predicted for the load dependent branch based on random data.

In connection with precomputing outcomes of load dependent branches, a stride prefetcher of the processor populates a table that is accessible to a decode unit of the processor based on training events. In one example, the stride prefetcher communicates a training event to the table (e.g., via a bus of the processor) based on a stride prefetch (e.g., when the stride prefetcher is updated or when it issues a prefetch request). In one or more implementations, the training events include a program counter value, a step size, and a confidence level. By way of example, the program counter value is an instruction address, and the step size corresponds to a difference between consecutive memory addresses accessed by instructions having a same program counter value. In at least one example, the confidence level is based on a number of times that instructions having the same program counter value have accessed consecutive memory addresses separated by the step size.

Using the populated table, the decode unit monitors load instructions in the instruction stream of the processor and compares program counter values of the load instructions to program counter values of entries included in the table. If a program counter value of a load instruction matches a program counter value of an entry in the table, then a destination location (e.g., a destination register) of the load instruction is captured and the matching entry in the table is updated to include the destination location.

In accordance with the described techniques, the decode unit also receives information from a branch predictor about conditional branch instructions of the instruction steam. By way of example, this information includes an identifier, a prediction accuracy, and a source register for a respective conditional branch instruction. In at least one variation, the identifier associates the conditional branch instruction with a particular loop iteration, and the prediction accuracy indicates a confidence in an outcome predicted for the conditional branch instruction. When the predicted outcome of a conditional branch instruction has a low prediction accuracy (e.g., that satisfies a low accuracy threshold), the predicted outcome is a candidate to be replaced with a precomputed outcome of the conditional branch instruction.

Using the information received about the conditional branch instructions, the decode unit monitors the source registers of the identified conditional branch instructions in the instruction stream to identify whether those instructions use a destination location of an active striding load included in the table. For example, the decode unit compares register numbers to determine if the monitored source registers of the incoming conditional branch instructions use a striding load's destination location, e.g., destination register. The decode unit detects that a conditional branch instruction is a load dependent branch instruction when the destination location of an active striding load is used (either directly or indirectly) in a monitored source register of the conditional branch instruction. The conditional branch instruction is “load dependent” because an outcome of the instruction (e.g., whether the branch is taken or not taken) depends on data of a future load instruction, which can be random and/or largely unpredictable. Despite the data itself being random, though, the load address is predictable.

Responsive to detecting a load dependent branch instruction, a branch detector injects, or otherwise inserts, an instruction into the decode instruction stream for fetching the data of the future load instruction. In one or more implementations, the injected instruction includes an address, which is determined by offsetting an address of the active striding load by a distance that is determined based on the step size of the active striding load, e.g., from the table.

The processor's load-store unit receives the injected instruction and fetches the data of the future load instruction. For example, the load-store unit writes the data of the future load instruction to a temporary location (or a register) of the processor that is available to the decode unit. In one or more implementations, the branch detector injects an additional instruction in the instruction stream, and an execution unit uses the additional instruction to precompute an outcome of a load dependent branch (e.g., according to whether the branch is determined to be taken or not taken), such as by using an address computed based on the data of the future load instruction. The precomputed outcome is stored in a precomputed branch table that is available to the branch predictor.

Using this table and the distance of the injected future load from the load instruction, a future iteration of a corresponding conditional branch instruction is identified. If the branch predictor has not yet reached the future iteration, then the branch predictor uses the precomputed outcome as the predicted outcome of the conditional branch before the outcome is known definitively. Since the actual outcome of the branch is not known definitively, respective instructions that correspond to the precomputed outcome are executed “speculatively.” If the branch predictor has already passed the future identifier, however, then the branch predictor optionally performs an early redirect. By performing an early redirect, many cycles are saved relative to a redirect performed by an execution unit.

Through inclusion of a branch detector along with use of the described techniques, a processor improves predictions for branches that are dependent on striding loads in a power-saving manner. Since the precomputed outcome for a load dependent conditional branch instruction is more accurate than outcomes predicted by conventionally configured branch predictors, use of the precomputed outcome improves performance of a processor in relation to conventional processors. For instance, this increases a likelihood that instructions speculatively executed based on the precomputed outcome will be usable rather than discarded. Additionally, even when the precomputed outcome is not used and an early redirect is performed, the early redirect still saves multiple cycles relative to a redirect performed by the execution unit. This also improves performance of the processor. As a result, the described techniques demonstrate substantial improvements in processor performance relative to a baseline which does not implement the described techniques.

In some aspects, the techniques described herein relate to a method including: detecting a load dependent branch instruction by identifying that a destination location of a load instruction is used in an operation for determining whether a conditional branch is taken or not taken, the load instruction included in a sequence of load instructions having addresses separated by a step size; and injecting an instruction in an instruction stream of a processor for fetching data of a future load instruction using an address of the load instruction offset by a distance based on the step size.

In some aspects, the techniques described herein relate to a method, further including injecting an additional instruction in an instruction stream for precomputing an outcome of a load dependent branch using an address computed based on an address of the operation and the data of the future load instruction.

In some aspects, the techniques described herein relate to a method, further including writing an indication of the outcome to a precomputed branch table.

In some aspects, the techniques described herein relate to a method, wherein the load dependent branch instruction is detected in a decode unit of the instruction stream.

In some aspects, the techniques described herein relate to a method, wherein the distance is a product of the step size and a number of steps.

In some aspects, the techniques described herein relate to a method, wherein the instruction is injected in the instruction stream via an injection bus of the processor.

In some aspects, the techniques described herein relate to a method, further including storing the data of the future load instruction in a temporary register or location that is accessible to a decode unit of the processor.

In some aspects, the techniques described herein relate to a method, wherein the operation is a compare operation and the load dependent branch instruction is detected based on a prediction accuracy for the conditional branch.

In some aspects, the techniques described herein relate to a method, wherein the load dependent branch instruction is detected based on a confidence level for the load instruction.

In some aspects, the techniques described herein relate to a system including: a decode unit of a processor configured to identify that a destination location of a load instruction is used in an operation for determining whether a conditional branch is taken or not taken, the load instruction included in a sequence of load instructions having addresses separated by a step size; and a branch detector of the processor configured to inject an instruction in an instruction stream of the processor for fetching data of a future load instruction using an address of the load instruction offset by a distance based on the step size.

In some aspects, the techniques described herein relate to a system, wherein the branch detector is further configured to inject an additional instruction in an instruction stream for precomputing an outcome of a load dependent branch using an address computed based on an address of the operation and the data of the future load instruction.

In some aspects, the techniques described herein relate to a system, further including an execution unit of the processor configured to write an indication of the outcome to a precomputed branch table.

In some aspects, the techniques described herein relate to a system, wherein the data of the future load instruction is stored in a temporary register or location that is accessible to the decode unit.

In some aspects, the techniques described herein relate to a system, wherein the distance is a product of the step size and a number of steps.

In some aspects, the techniques described herein relate to a system, wherein the instruction is injected in the instruction stream via an injection bus of the processor.

In some aspects, the techniques described herein relate to a method including: detecting a load dependent branch instruction by identifying that a destination location of a load instruction is used in an operation for determining whether a conditional branch is taken or not taken, the load instruction included in a sequence of load instructions having addresses separated by a step size; and injecting an instruction in an instruction stream of a processor for precomputing an outcome of a load dependent branch based on an address of the operation and data of a future load instruction fetched using the step size.

In some aspects, the techniques described herein relate to a method, wherein the data of the future load instruction is fetched using an address of the load instruction offset by a distance based on the step size.

In some aspects, the techniques described herein relate to a method, further including storing the data of the future load instruction in a temporary register or location that is accessible to a decode unit of the processor.

In some aspects, the techniques described herein relate to a method, further including writing an indication of the outcome to a precomputed branch table.

In some aspects, the techniques described herein relate to a method, wherein the operation is a compare operation and the load dependent branch instruction is detected based on a prediction accuracy for the conditional branch.

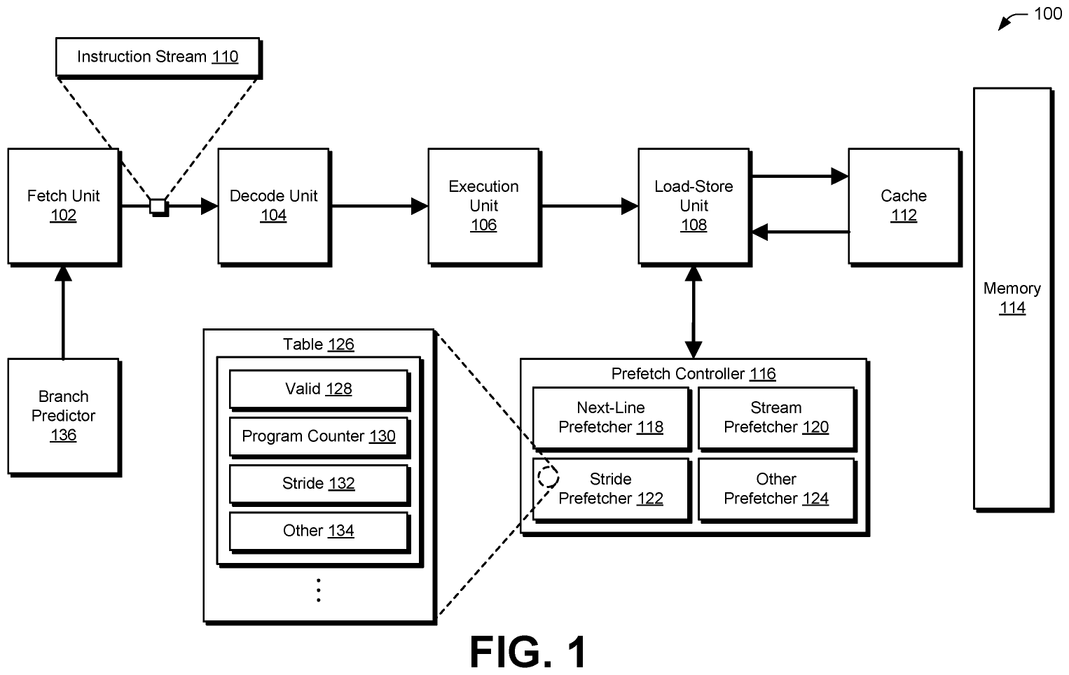

FIG. 1 is a block diagram of a non-limiting example system 100 having a prefetch controller for prefetching data likely to be requested by an execution unit of the system in one or more implementations. In particular, the system 100 includes a fetch unit 102, a decode unit 104, an execution unit 106, and a load-store unit 108 of a processor.

In one or more implementations, a program counter (not shown) of the processor indicates an instruction that is to be processed by the processor as part of an instruction stream 110. By way of example, the fetch unit 102 fetches the instruction indicated by the program counter and the decode unit 104 decodes the fetched instruction for execution by the execution unit 106. In at least one variation, the program counter is incremented, after the instruction is fetched, to indicate a next instruction to be executed as part of the instruction stream 110.

In accordance with the described techniques, the execution unit 106 requests data to execute the instruction. In variations, a cache 112 is initially searched for the requested data. In one or more implementations, the cache 112 is a memory cache, such as a particular level of cache (e.g., L1 cache or L2 cache) where the particular level is included in a hierarchy of multiple cache levels (e.g., L0, L1, L2, L3, and L4). If the requested data is available in the cache 112 (e.g., a cache hit), then the load-store unit 108 is able to quickly provide the requested data from the cache 112. However, if the requested data is not available in the cache 112 (e.g., a cache miss), then the requested data is retrieved from a data store, such as memory 114.

It is to be appreciated that the memory 114 (e.g., random access memory) is one example of a data store from which data is retrievable when not yet stored in the cache 112 and/or from which data is loadable into the cache 112, e.g., using the prefetching techniques described above and below. Other examples of a data store include, but are not limited to, an external memory, a higher-level cache (e.g., L2 cache when the cache 112 is an L1 cache), secondary storage (e.g., a mass storage device), and removable media (e.g., flash drives, memory cards, compact discs, and digital video disc), to name just a few. Notably, serving the requested data from the data store when a cache miss occurs is slower than serving the requested data from the cache 112 when a cache hit occurs.

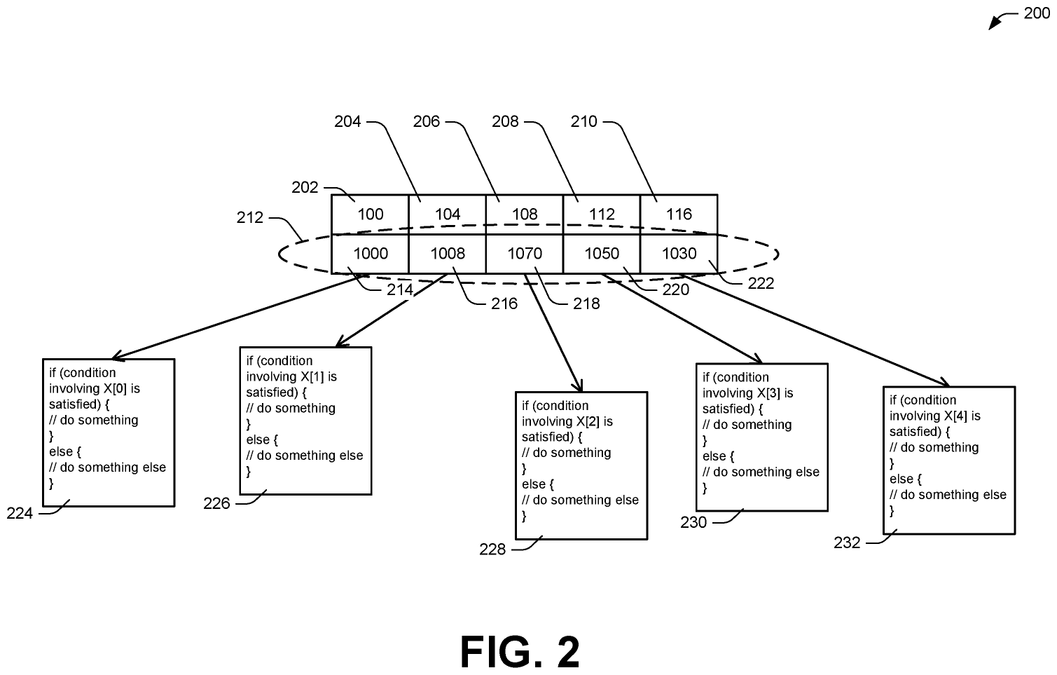

In order to avoid cache misses which increase latency, the load-store unit 108 includes a prefetch controller 116 that identifies patterns in memory addresses accessed as the execution unit 106 executes instructions. The identified patterns are usable to determine memory addresses of the memory 114 that contain data which the execution unit 106 will likely request in the future. The prefetch controller 116 and/or the load-store unit 108 “prefetch” the data from the determined memory addresses of the memory 114 and store the prefetched data in the cache 112, e.g., before the execution unit 106 requests the prefetched data for execution of an instruction of the instruction stream 110 that uses the prefetched data. In accordance with the described techniques, for example, the data requested in connection with executing the instruction, and that is prefetched, corresponds to an array, an example of which is discussed in more detail in relation to FIG. 2.

The prefetch controller 116 is capable of identifying a variety of different types of patterns in the memory addresses accessed as the execution unit 106 executes instructions included in the instruction stream 110. In the illustrated example, the prefetch controller 116 includes a variety of prefetchers which correspond to examples of those different types of patterns. It is to be appreciated, however, that in one or more implementations, the prefetch controller 116 includes fewer, more, or different prefetchers without departing from the spirit or scope of the described techniques. By way of example, and not limitation, the prefetch controller 116 includes a next-line prefetcher 118, a stream prefetcher 120, a stride prefetcher 122, and an other prefetcher 124.

In one or more implementations, the next-line prefetcher 118 identifies a request for a line of data and prefetches (e.g., communicates a prefetch instruction to the load-store unit 108) a next line of data for loading into the cache 112. The stream prefetcher 120 is capable of prefetching data multiple lines ahead of data requested, such as by identifying a first data access of a stream, determining a direction of the stream based on a second data access of the stream, and then, based on a third data access, confirming that the first, second, and third data accesses are associated with the stream. Based on this, the stream prefetcher 120 begins prefetching data of the stream, e.g., by communicating at least one prefetch instruction to the load-store unit 108.

The stride prefetcher 122 is similar to the stream prefetcher 120, but the stride prefetcher 122 is capable of identifying memory address access patterns which follow a “stride” or a “step size,” such as by identifying a pattern in a number of locations in memory between beginnings of locations from which data is accessed. In one or more implementations, a “stride” or “step size” is measured in bytes or in other units.

In one example, the stride prefetcher 122 identifies a location in memory (e.g., a first memory address) of a beginning of a first element associated with an access. In this example, the stride prefetcher 122 determines a direction and the “step size” or “stride” based on a location in memory (e.g., a second memory address) of a beginning of a second element associated with the access, such that the stride or step size corresponds to the number of locations in memory between the beginnings of the first and second elements. Based on further determining that a location in memory (e.g., a third memory address) of a beginning of a third element associated with the access is also the “stride” or “step size” away from the location in memory of the beginning of the second element, the stride prefetcher 122 confirms the pattern, in one or more implementations. The stride prefetcher 122 is then configured to begin prefetching the respective data based on the stride or step size.

In at least one variation, the stride prefetcher 122 stores a program counter value, a stride or step size, and/or other information, examples of which include a confidence level and a virtual address. In the illustrated example, the stride prefetcher 122 is depicted including, or otherwise having access to, table 126. Further, the table 126 is depicted having an entry with a valid 128 field, a program counter 130 field, a stride 132 field, and an other 134 field. In one or more implementations, the table 126 includes one or more entries that correspond to at least one sequence of instructions processed by the system 100. The inclusion of the ellipses in the illustration represents the capability of the table 126 to maintain more than one entry, in at least one variation. For each entry in the table 126 associated with an instruction sequence, respective values are stored in the table 126's fields, e.g., in the valid 128 field, the program counter 130 field, the stride 132 field, and/or the other 134 field.

In one example, an entry in the table 126 corresponds to a sequence of load and store instructions. In the program counter 130 field, the load-store unit 108 or the prefetch controller 116 stores a program counter value, which in one or more scenarios is an instruction address that is shared by the instructions (e.g., sequential instructions) in the sequence of instructions. In at least one variation, a mere portion of the program counter value is stored in the program counter 130 field of the entry to reduce a number of bits used to store the entry in the table 126, e.g., relative to including an entire program counter value in the field for the entry. In other examples, a program counter hash value is computed from the program counter value (e.g., using a hash function) and is stored in the program counter 130 field to reduce a number of bits used to store the entry in the table 126.

In the stride 132 field, the load-store unit 108 or the prefetch controller 116 stores the determined step size between the locations in memory (e.g., memory addresses) accessed at the beginnings of elements of an array for instructions (e.g., sequential instructions) in the sequence of instructions. In one or more implementations, the table 126 stores other information for an entry in the other 134 field, such as confidence levels, virtual addresses, and various other information. By way of example, the other information includes a number of the memory addresses accessed by the instructions in the sequence of instructions which are separated by the step size indicated in the stride 132 field.

The other prefetcher 124 is representative of additional data prefetching functionality. In one or more variations, for instance, the other prefetcher 124 is capable of correlation prefetching, tag-based correlation prefetching, and/or pre-execution based prefetching, to name just a few. In one or more implementations, the prefetching functionality of the other prefetcher 124 is used to augment or replace functionality of the next-line prefetcher 118, the stream prefetcher 120, and/or the stride prefetcher 122.

As noted above, in at least one variation, the program counter is incremented, after the instruction is fetched, to indicate a next instruction to be executed as part of the instruction stream 110. If the sequence of incoming instructions includes a conditional branch instruction (or a conditional jump), then a branch predictor 136 predicts whether its branch (or its jump) will be taken or not taken. The reason for this prediction is because it is not definitively known whether the branch (or the jump) will be taken or not taken until its condition is actually computed during execution, e.g., in the execution unit 106. If, during execution, an outcome of the conditional branch instruction is that the branch is taken, then the program counter is set to an argument (e.g., an address) of the conditional branch instruction. However, if, during execution, the outcome of the conditional branch instruction is that the branch is not taken, then the program counter indicates that an instruction following the conditional branch instruction is a next instruction to be executed in the sequence of incoming instructions. The branch predictor 136 is configured to predict whether branches are taken or not so that instructions are fetchable for speculative execution, rather than waiting to execute those instructions until the outcome (to take a branch or not) is computed during execution. When the system 100 waits to execute those instructions, it incurs a delay in processing.

In an attempt to avoid such a delay, if the branch predictor 136 predicts that the branch will not be taken, then the branch predictor 136 causes the instruction following the conditional branch instruction to be fetched and speculatively executed. Alternatively, if the branch predictor 136 predicts that the branch will be taken, then the branch predictor 136 causes an instruction at a memory location indicated by the argument of the conditional branch instruction to be fetched and speculatively executed. When the branch predictor 136 correctly predicts the outcome of the conditional branch instruction, then the speculatively executed instruction is usable and this avoids the above-noted delay. However, if the branch predictor 136 incorrectly predicts the outcome of the conditional branch instruction, then the speculatively executed instruction is discarded and the fetch unit 102 fetches the correct instruction for execution by the execution unit 106 which does incur the delay. Accordingly, increasing an accuracy of branch outcomes predicted by the branch predictor 136 reduces the number of incorrect predictions and thus the delays that correspond to such incorrect predictions, which is one way to improve the processor's performance. In the context of identifying striding loads associated with load dependent branches, consider the following discussion of FIG. 2.

FIG. 2 illustrates a non-limiting example 200 of a representation of an array having elements used in conditional branches. In this example 200, the representation depicts a first memory address 202, a second memory address 204, a third memory address 206, a fourth memory address 208, and a fifth memory address 210, which correspond to locations in memory of beginnings of elements of array 212. Further, the elements of the array 212 are used in conditional branches.

In the example 200, the array 212's elements include a first element 214, a second element 216, a third element 218, a fourth element 220, and a fifth element 222. As illustrated, the first memory address 202 corresponds to a beginning of the first element 214 of the array 212. The first element 214 is further used in a conditional branch 224 involving that element (e.g., X[0]). Also in this example, the second memory address 204 corresponds to a beginning of the second element 216 of the array 212, and the second element 216 is further used in a conditional branch 226 involving that element (e.g., X[1]); the third memory address 206 corresponds to a beginning of the third element 218 of the array 212, and the third element 218 is further used in a conditional branch 228 involving that element (e.g., X[2]); the fourth memory address 208 corresponds to a beginning of the fourth element 220 of the array 212, and the fourth element 220 is further used in a conditional branch 230 involving that element (e.g., X[3]); and the fifth memory address 210 corresponds to a beginning of the fifth element 222 of the array 212, and the fifth element 222 is further used in a conditional branch 232 involving that element (e.g., X[4]). It is to be appreciated that the array 212 is merely an example, and that the described techniques operate on arrays of different sizes and that point to different types of conditional branches without departing from the spirit or scope of the techniques described herein. By way of example, in one or more implementations, conditional branches involve comparing the elements of the arrays to constants, comparing results of functions applied to the elements of the array (using the value directly), or comparing the elements of the arrays to another source register, to name just a few.

In this example 200, a difference between the memory addresses 202-210, which correspond to locations in memory of beginnings of successive elements of the array 212, is four (e.g., four bytes). Thus, in this example 200, the stride or step size of the array 212 is four. Accordingly, the memory addresses 202-210 are predictable using the difference of four. If the array 212 includes a sixth element (not shown), a sixth memory address at which the sixth element of the array 212 begins is likely equal to the fifth memory address 210 (e.g., ‘116’) plus four (e.g., or ‘120’). It is to be appreciated that in various systems and depending on various conditions, a difference in memory addresses which correspond to locations in memory of beginnings of successive elements of an array is different from four without departing from the spirit or scope of the described techniques.

Unlike the memory addresses 202-210 which are predictable using the difference of four, the branch conditions do not follow such a pattern in the illustrated example. In the context of improving conditional branch prediction, consider the following example.

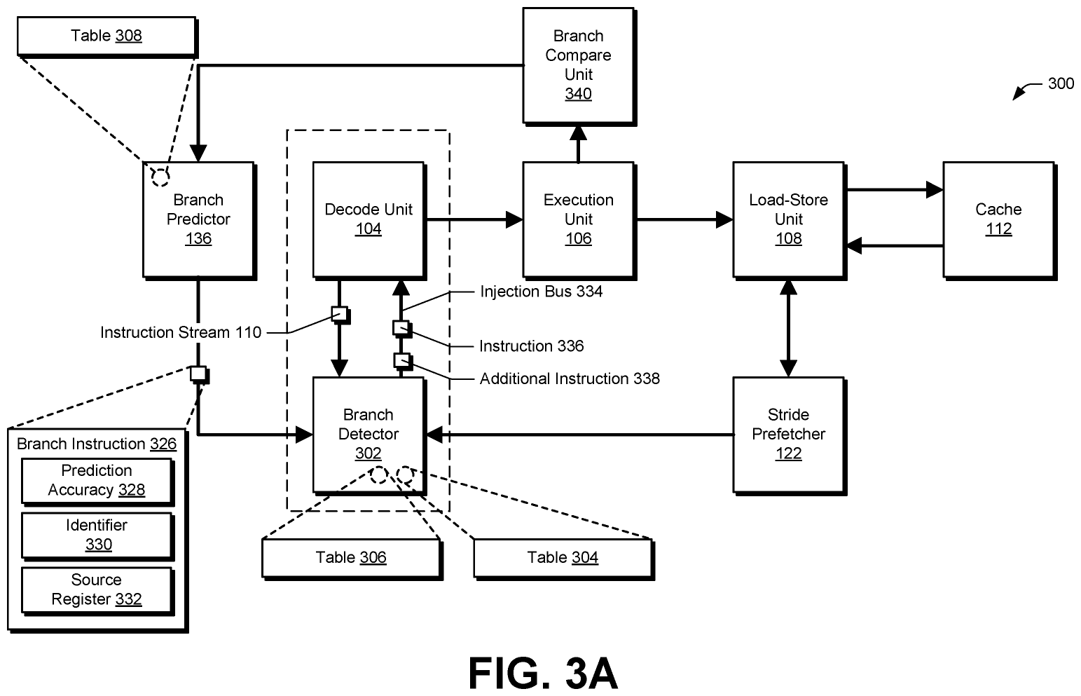

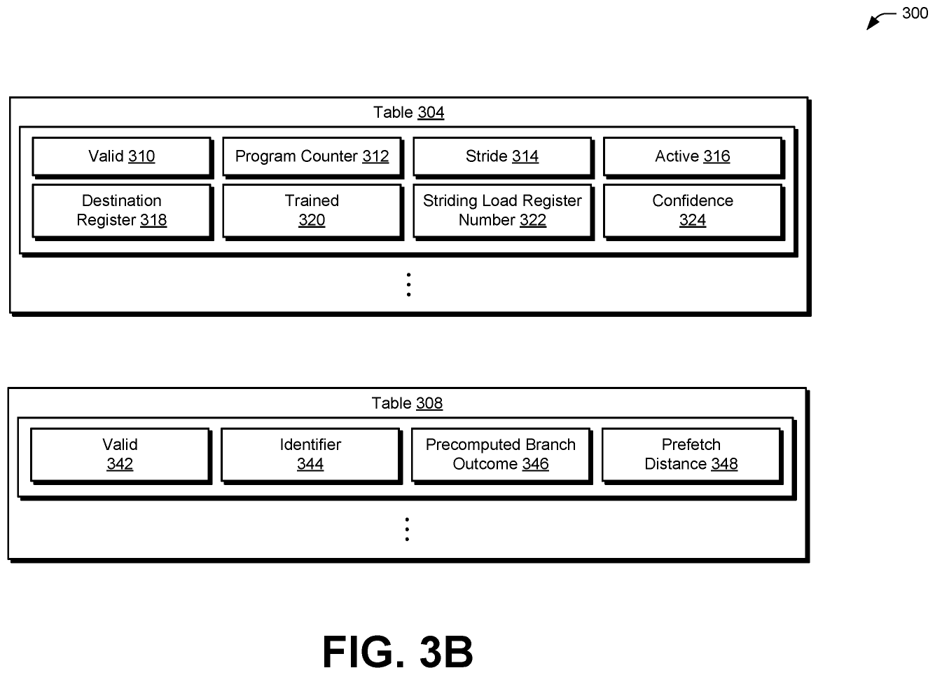

FIGS. 3A and 3B illustrate a non-limiting example 300 of a system that improves branch prediction by precomputing outcomes of load dependent branches based on predictability of addresses for future load instructions.

FIG. 3A illustrates the example 300 of the system having a branch detector in one or more implementations. In particular, the example 300 of the system includes the decode unit 104, the execution unit 106, the load-store unit 108, the cache 112, the stride prefetcher 122, and the branch predictor 136. In one or more implementations, the example 300 system also includes a branch detector 302, which is part of the decode unit 104 or is otherwise accessible to the decode unit 104 in one or more implementations. In accordance with the described techniques, the stride prefetcher 122 and the branch predictor 136 both train the branch detector 302 to monitor the incoming instruction stream 110 to identify striding load driven branch pairs, where the branch outcome is dependent on a high confidence striding load and the branch itself has a low prediction accuracy, as described below.

In this example 300, the branch detector 302 includes, or otherwise has access to, a table 304 and a table 306. Alternatively or in addition, the decode unit 104 includes, or otherwise has access to, the table 304 and the table 306. The branch predictor 136 also includes, or otherwise has access to, a table 308.

FIG. 3B illustrates tables available to the example 300 of the system in one or more implementations in greater detail. In particular, FIG. 3B depicts the table 304 and the table 308 in greater detail. As discussed below, the table 306 is populated to maintain information about branch instructions and is not depicted in FIG. 3B. In one or more implementations, the stride prefetcher 122 populates the table 304 to maintain information about striding loads. In this example, the table 304 includes an entry having a valid 310 field, a program counter 312 field, a stride 314 field, an active 316 field, a destination register 318 field, a trained 320 field, a striding load register number 322 field, and a confidence 324 field. It is to be appreciated that in one or more implementations, the table 304 includes different fields without departing from the spirit or scope of the described techniques. The table 304 is illustrated with ellipses to represent that the table 304 is capable of maintaining a plurality of entries with such fields.

As part of training the branch detector 302, the stride prefetcher 122 detects striding loads and populates the table 304 with information about those loads. In the context of populating the table 304, the stride prefetcher 122 communicates training events (e.g., via a bus of the processor) to the table 304 that include a program counter value, a step size (a stride), and a confidence level each time the stride prefetcher 122 makes a prefetch request. The program counter value is an instruction address and the step size is a difference between consecutive memory addresses accessed by instructions having the same program counter value (e.g., instructions in a loop). The confidence level is a number of times that instructions having the same program counter value access consecutive memory addresses that are separated by the step size. In order to populate the table 304, the program counter value of each training event is compared with a program counter value stored in the program counter 312 field of each entry in the table 304. A program counter value of a training event either matches a program counter value stored in the program counter 312 field of at least one entry in the table 304 or does not match the program counter value stored in the program counter 312 field of any of the entries in the table 304.

In accordance with the described techniques, the stride prefetcher 122 populates the table 304 based, in part, on a confidence level of the training event. In one example, a training event matches an entry in the table 304, e.g., when the program counter value of the training event matches the program counter value in an entry's program counter 312 field. If a confidence level of the training event is low (e.g., does not satisfy a threshold confidence level), then the entry is invalidated by setting a value stored in the valid 310 field so that it indicates the entry is invalid. In one or more implementations, the valid 310 field corresponds to a validity bit, and an entry is invalidated by setting the validity bit of the valid 310 field equal to ‘0.’ By way of contrast, an entry is valid in one or more implementations when the validity bit of the valid 310 field equal to ‘1.’ It is to be appreciated that the valid 310 field may indicate validity and invalidity in other ways without departing from the spirit or scope of the described techniques. In a scenario where a training event matches an entry in the table and the confidence level of the training event is high (e.g., satisfies the threshold confidence level), then a step size of the training event is usable to update the stride 314 field of the respective entry, e.g., if the step size of the training event does not match a step size already stored in the stride 314 field of the entry.

In one example, a training event does not match an entry in the table 304, e.g., when the program counter value of the training event does not match the program counter value in any entry's program counter 312 field. In this example, if a confidence level of the training event is low (e.g., does not satisfy the threshold confidence level), then the training event is discarded and the table 304 is not updated based on the training event. Instead, a program counter value of a subsequent training event is compared to the program counter values included in the program counter 312 fields of the table 304's entries.

By way of contrast to the scenario discussed just above, if the confidence level of the non-matching training event is high (e.g., satisfies the threshold confidence level), then a new entry is added to the table 304 and the valid 310 field is set to indicate that the new entry is valid, e.g., by setting a validity bit of the new entry's valid 310 field equal to ‘1’. The new entry in the table 304 is further populated based on the training event. For example, the program counter 312 field of the new entry in the table 304 is updated to store the program counter value of the training event, and the stride 314 field of the new entry in the table 304 is updated to store the step size of the training event.

After the table 304 is populated based on the training events from the stride prefetcher 122, the decode unit 104 accesses the table 304 to compare program counter values of load instructions in the instruction stream 110 to the program counter values included in the program counter 312 field of entries in the table 304, such as by using a content addressable memory so that the comparisons are completed quickly, e.g., in one clock cycle. In one or more implementations, the load instructions for which the values are compared are “younger” instructions, which in at least one example are instructions received after the table 304 is populated with an entry having a matching program counter value. If a matching younger instruction is found, then the entry in the table 304 that matches is an active striding load.

In addition to the training by the stride prefetcher 122, the branch detector 302 is also trained by the branch predictor 136. In accordance with the described techniques, for instance, the branch predictor 136 communicates (e.g., via a bus of the processor) a branch instruction 326 to the branch detector 302 for each conditional branch instruction identified by the branch predictor 136. In accordance with the described techniques, the branch instruction 326 includes a prediction accuracy 328, an identifier 330, and a source register 332 of a conditional branch instruction.

Broadly, the identifier 330 identifies the conditional branch instruction, and the identifier 330 is configurable in different ways in various implementations, examples of which include as a program counter value or a hash of the program counter value. In one or more implementations, the identifier 330 associates the conditional branch instruction with a particular loop iteration. The prediction accuracy 328 represents a level of confidence in a predicted outcome of the respective conditional branch instruction. The inclusion of the prediction accuracy 328 as part of the branch instruction 326 differs from conventionally configured branch instructions, which do not include such a prediction accuracy. In one or more implementations, a branch instruction 326 is associated with multiple sources, such that the instruction includes more than one source register 332. In such implementations, the other source registers—not the source register corresponding to the striding load—correspond to invariants in the respective loop.

The branch instructions 326 communicated by the branch predictor 136 are used to populate the table 306. By way of example, the table 306 includes one or more entries, and each entry corresponds to at least one branch instruction 326. In one or more implementations, an entry in the table 306 includes fields which capture the information of the branch instruction 326, e.g., a field to capture the prediction accuracy 328, the identifier 330, and the source register 332 of the branch instruction 326. Branch instructions with different identifiers correspond to different entries in the table 306. In accordance with the described techniques, each entry also includes a confidence field. In at least one variation, the confidence field of an entry is updated (e.g., to indicate more confidence) when a received branch instruction matches a striding load having an entry in the table 304. It is to be appreciated that a confidence of an entry in the table 306 is updated based on different events in one or more implementations.

As part of determining whether the branch instruction 326 is “load dependent,” the branch detector 302 determines whether the source register 332 indicated in the branch instruction 326 uses a destination register of an active striding load, e.g., based on matching the destination register 318 field of an entry in the table 304. The branch detector 302 identifies candidates for injecting instructions (e.g., for precomputing branch outcomes) by identifying instructions having a low prediction accuracy 328 and by identifying that a destination register 318 field of an entry in the table 304, which corresponds to an active striding load, matches the source register 332 field of an identified instruction. In one or more implementations, the confidence 324 field of an entry that corresponds to an active striding load indicates a high confidence in the striding load. By way of example, a “high” confidence that an entry in the table 304 corresponds to a striding load is based on a value indicative of confidence in the confidence 324 field satisfying a threshold confidence.

Notably, by attempting to match the destination register 318 field of entries in the table 304 with the source register 332 field of the branch instruction 326, the branch detector 302 compares register numbers of instructions rather than memory addresses. Because register numbers are generally smaller than memory addresses (e.g., 5-bit versus 64-bit), the hardware required to identify striding load driven branch pairs by the described system is reduced relative to conventional techniques.

In one or more examples, the destination register included in the destination register 318 field is used directly by the source register 332. In other examples, the match is identified by determining that the destination register, indicated in the destination register 318 field of an active striding load's entry, is used in an operation for determining whether a branch of a particular conditional branch instruction is taken or not taken. For example, the particular conditional branch instruction is a conditional jump instruction and the destination register, included in the destination register 318 field of the active striding load's entry, is used in a compare operation (or another operation) which determines whether or not a condition is satisfied for jumping to an instruction specified by the conditional jump instruction.

Based on matching a striding load with a conditional branch (a “striding load driven branch pair”) and once both the striding load and the conditional branch have confidences that satisfy respective thresholds, the branch detector 302 injects instructions into the instruction stream 110 via an injection bus 334 of the processor. These injected instructions flow through the instruction stream 110 and are capable of being executed by the execution unit 106 or flowing through the execution unit 106 to the load-store unit 108 (depending on a configuration of the instruction). As mentioned above, in order to be eligible for instruction injections, an active striding load that matches a branch is associated with a confidence level that satisfies (e.g., is equal to or greater than) a first threshold confidence level and a conditional branch is also associated with a confidence level that satisfies a second threshold. Additionally or alternatively, eligibility for instruction injection is based on whether at least one load dependent branch that matches the active striding load is associated with an accuracy level that satisfies (e.g., is less than) a threshold accuracy—the accuracy level being indicated in the prediction accuracy 328 field of an entry associated with the load dependent branch.

Responsive to identifying an eligible striding load driven branch pair, the branch detector 302 is configured to operate in an insertion mode. In insertion mode, the branch detector 302 inserts an instruction 336 via the injection bus 334 for fetching data of a future load instruction. The injected instruction 336 uses an address of the active striding load offset by a distance that is based on its corresponding step size indicated in the stride 314 field of the table 304. In an example, the data of the future load instruction is written to at least a portion of a temporary register (not shown) or location of the processor. In one or more implementations, a temporary register number of this temporary register is included in the striding load register number 322 field of the table 304. The temporary register is accessible to the decode unit 104 and/or the branch detector 302.

In accordance with the described techniques, the branch detector 302 also inserts an additional instruction 338 via the injection bus 334. The additional instruction 338 is configured according to the respective conditional branch instruction that is determined to depend on an identified, active striding load. The additional instruction 338 is further configured to include data of a future load (of the active striding load), e.g., in place of the source register 332 indicated in the respective branch instruction 326. The execution unit 106 receives the additional instruction 338 and uses the additional instruction 338 to precompute the outcome of the respective load dependent branch, which has a prediction accuracy 328 that satisfies (e.g., is less than or equal to) a prediction accuracy threshold. In at least one example, the execution unit 106 precomputes the outcome of the load dependent branch according to the additional instruction 338 and does not set any architectural flags. This eliminates handling of any temporary flags in some scenarios. In one or more implementations, the system and/or the execution unit 106 includes a branch compare unit 340, which precomputes the outcome of the future load dependent branch. Alternatively, the branch compare unit 340 receives the precomputed outcome of the load dependent branch, e.g., from the execution unit 106.

The precomputed outcome of the load dependent branch (e.g., whether the branch is taken or not taken) is communicated to the table 308 which is accessible to the branch predictor 136, e.g., the table 308 is maintained at the branch predictor 136. In one or more implementations, the table 308 includes one or more entries having a valid 342 field, an identifier 344 field, a precomputed branch outcome 346 field, and a prefetch distance 348 field. It is to be appreciated that the table 308 is configured differently, e.g., with different fields, in one or more variations.

In accordance with the described techniques, the precomputed branch outcome 346 field is updated (e.g., by the branch compare unit 340) to include the precomputed outcome discussed above for an entry that corresponds to the respective branch. By way of example, the precomputed outcome of the load dependent branch indicates that the branch will be taken. In this scenario, the precomputed branch outcome 346 field is populated with an indication (e.g., a value) that indicates the branch will be taken. In an alternative example, the precomputed outcome of the load dependent branch indicates that the branch will not be taken. In this alternate scenario, the precomputed branch outcome 346 field is populated with an indication (e.g., a value) that indicates the branch will not be taken.

Using precomputed branch outcomes from the table 308, the branch predictor 136 improves its predicted outcomes. Consider a first example in which the branch predictor 136 has not yet reached a future iteration of a load dependent branch, which corresponds to an entry in the table 308. In this first example, the branch predictor 136 uses the precomputed outcome (the branch will be taken) instead of a predicted outcome, and instructions are speculatively executed based on the precomputed outcome. The speculatively executed instructions (executed based on the precomputed outcome) are more likely to be usable than instructions speculatively executed based on the predicted outcome for the conditional branch instruction, which has the low prediction accuracy 328.

Consider also a second example in which the branch predictor 136 has already passed an iteration of a load dependent branch that corresponds to an entry in the table 308. This occurs, for instance, when a precomputed outcome is not yet available in the table 308 and instructions are speculatively executed based on a precomputed outcome for a conditional branch instruction (which has the low prediction accuracy 328). In this second example, the branch predictor 136 is capable of performing an early redirect which saves many cycles relative to a redirect from the execution unit 106. Accordingly, performance of the processor is improved in both the first example and the second example.

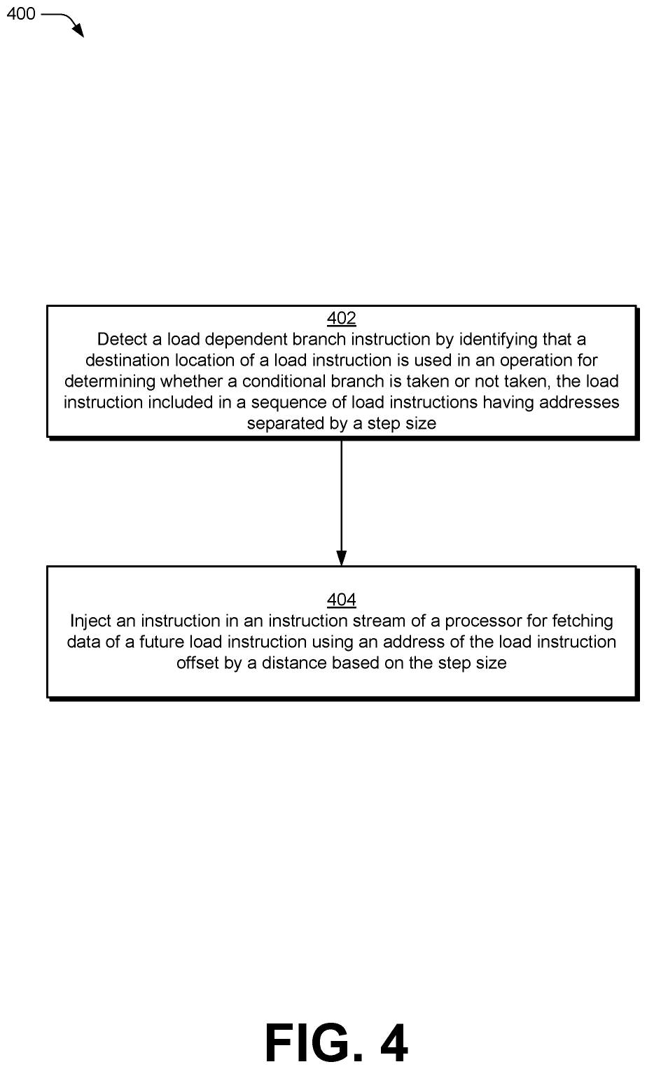

FIG. 4 depicts a procedure 400 in an example implementation of injecting an instruction in an instruction stream of a processor for fetching data of a future load instruction.

A load dependent branch instruction is detected (block 402) by identifying that a destination location of a load instruction is used in an operation for determining whether a conditional branch is taken or not taken, the load instruction included in a sequence of load instructions having addresses separated by a step size. For example, the conditional branch is a compare operation immediately followed by a conditional jump instruction. In an example, the branch detector 302 detects the load dependent branch instruction as corresponding to branch instruction 326 that uses a destination location included in the destination register 318 field of the table 304 in the source register 332 field.

An instruction is injected in an instruction stream of a processor for fetching data of a future load instruction using an address of the load instruction offset by a distance based on the step size (block 404). For example, the branch detector 302 injects the instruction 336 for fetching the data of the future load instruction in the instruction stream 110 via the injection bus 334.

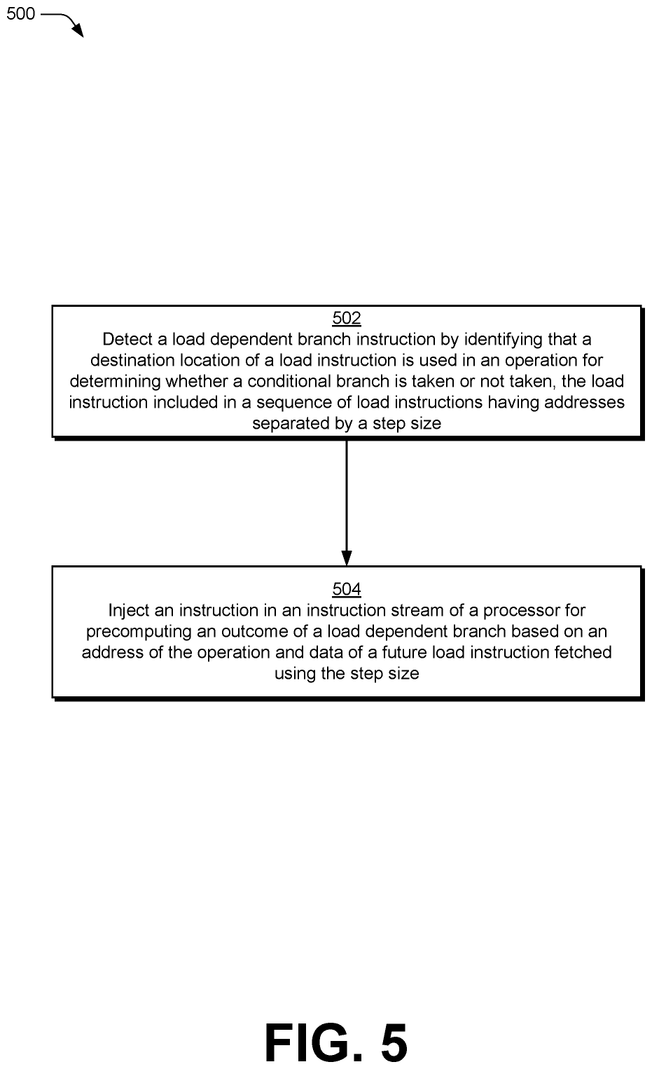

FIG. 5 depicts a procedure 500 in an example implementation of injecting an instruction in an instruction stream of a processor for precomputing an outcome of a load dependent branch.

A load dependent branch instruction is detected (block 502) by identifying that a destination location of a load instruction is used in an operation for determining whether a conditional branch is taken or not taken. In accordance with the principles discussed herein, the load instruction is included in a sequence of load instructions having addresses separated by a step size. By way of example, the conditional branch is a compare operation immediately followed by a conditional jump instruction. Further, the branch detector 302 detects the load dependent branch instruction using the branch instruction 326.

An instruction is injected in an instruction stream of a processor for precomputing an outcome of a load dependent branch based on an address of the operation and data of a future load instruction fetched using the step size (block 504). For example, data of a future load instruction is used in the instruction. In an example, the branch detector 302 injects the additional instruction 338 in the instruction stream 110 via the injection bus 334.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the decode unit 104, the execution unit 106, the load-store unit 108, the branch predictor 136, the stride prefetcher 122, the branch detector 302, and the branch compare unit 340) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), an accelerated processing unit (APU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
detecting a load dependent branch instruction by identifying that a destination location of a load instruction is used in an operation for determining whether a conditional branch is taken or not taken, the load instruction included in a sequence of load instructions having addresses separated by a step size; and
injecting an instruction in an instruction stream of a processor for fetching data of a future load instruction using an address of the load instruction offset by a distance based on the step size.

2. The method of claim 1, further comprising injecting an additional instruction in an instruction stream for precomputing an outcome of a load dependent branch using an address computed based on an address of the operation and the data of the future load instruction.

3. The method of claim 2, further comprising writing an indication of the outcome to a precomputed branch table.

4. The method of claim 1, wherein the load dependent branch instruction is detected in a decode unit of the instruction stream.

5. The method of claim 1, wherein the distance is a product of the step size and a number of steps.

6. The method of claim 1, wherein the instruction is injected in the instruction stream via an injection bus of the processor.

7. The method of claim 1, further comprising storing the data of the future load instruction in a temporary register or location that is accessible to a decode unit of the processor.

8. The method of claim 1, wherein the operation is a compare operation and the load dependent branch instruction is detected based on a prediction accuracy for the conditional branch.

9. The method of claim 1, wherein the load dependent branch instruction is detected based on a confidence level for the load instruction.

10. A system comprising:
a decode unit of a processor configured to identify that a destination location of a load instruction is used in an operation for determining whether a conditional branch is taken or not taken, the load instruction included in a sequence of load instructions having addresses separated by a step size; and
a branch detector of the processor configured to inject an instruction in an instruction stream of the processor for fetching data of a future load instruction using an address of the load instruction offset by a distance based on the step size.

11. The system of claim 10, wherein the branch detector is further configured to inject an additional instruction in an instruction stream for precomputing an outcome of a load dependent branch using an address computed based on an address of the operation and the data of the future load instruction.

12. The system of claim 11, further comprising an execution unit of the processor configured to write an indication of the outcome to a precomputed branch table.

13. The system of claim 10, wherein the data of the future load instruction is stored in a temporary register or location that is accessible to the decode unit.

14. The system of claim 10, wherein the distance is a product of the step size and a number of steps.

15. The system of claim 10, wherein the instruction is injected in the instruction stream via an injection bus of the processor.

16. A method comprising:
detecting a load dependent branch instruction by identifying that a destination location of a load instruction is used in an operation for determining whether a conditional branch is taken or not taken, the load instruction included in a sequence of load instructions having addresses separated by a step size; and
injecting an instruction in an instruction stream of a processor for precomputing an outcome of a load dependent branch based on an address of the operation and data of a future load instruction fetched using the step size.

17. The method of claim 16, wherein the data of the future load instruction is fetched using an address of the load instruction offset by a distance based on the step size.

18. The method of claim 17, further comprising storing the data of the future load instruction in a temporary register or location that is accessible to a decode unit of the processor.

19. The method of claim 16, further comprising writing an indication of the outcome to a precomputed branch table.

20. The method of claim 16, wherein the operation is a compare operation and the load dependent branch instruction is detected based on a prediction accuracy for the conditional branch.
